(19) United States
(12) Patent Application Publication
(10) Pub. No.: US 2010/0000571 A1
(43) Pub. Date: Jan. 7, 2010

(54) Bottle Sanitizing Device and Method

(76) Inventor: Damon Rosenaur, Dallas, TX (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/498,286

(22) Filed: Jul. 6, 2009

Related U.S. Application Data
(60) Provisional application No. 61/078,420, filed on Jul. 6, 2008.

(51) Int. Cl. B08B 3/08; A47L 25/00; B65D 51/00; B65D 41/00; B08B 1/00

(52) U.S. Cl. 134/6; 15/244.1; 215/228; 215/316; 426/112

(57) ABSTRACT

A device and method for cleaning and sanitizing water bottles and consumable liquid containers such as soda and juice bottles. The device positions a cleaning pad immediately adjacent to the container available for employment by a user during opening of the container by removing a cap. The cleaning pad may be housed in a container affixed to the cap of the drink container or may be housed within a cavity formed integral to the cap covering the drink container.

This application claims priority to U.S. Provisional Patent Application No. 61/078,420 filed Jul. 5, 2008 and which is incorporated herein in its entirety by reference.

### FIELD OF THE INVENTION

The disclosed device relates to bottles employed for consumable liquids such as drinking water bottles or other bottled liquids sold for consumption. More particularly, it relates to a device and method for sanitizing drinking bottles in general and in a particularly preferred mode, the portions of conventional water bottles which are inverted atop a drinking water dispenser or water cooler such as plastic and glass five-gallon water bottles.

### BACKGROUND OF THE INVENTION

In modern countries such as the United States, as well as in third work countries, clean drinking water is something continually sought by most people. In the United States and many modern industrialized countries, consumable liquids are dispensed in plastic and glass bottles from the factory which may or may not be kept clean during their trip from the factory to the retailer. Additionally, consumable liquids sold in stores are subject to handling by customers and employees who might be carrying communicable diseases.

While the interior of these containers may be kept clean by the cap or lid, thereby keeping the consumable liquid clean and disease and contaminant free, the exterior is, as can be discerned, subject to the contamination threats noted above. The exterior surfaces are subjected to many contaminants, germs, and bacteria during shipment. Consequently, the user who employs the same container holding the liquid as the vessel to drink it from, can be exposing themselves to a plethora of contaminants and potential diseases, which the exterior of the container picked up on the trip from the factory to their hand.

One especially ignored drink container is employed in combination atop a water cooler or dispenser which is a common sight at most offices and at many homes. Such dispensers generally have a spigot connected to a crock. The crock has an open upper end providing access to a reservoir for the spigot.

In use, a large plastic or glass water bottle is inverted and the neck of the bottle is inserted into the crock along with a portion of the bottle surrounding the neck. While the bottle is being inverted into position, water is usually draining from the neck and into the crock and ceases soon after the bottle is seated on the crock or adjacent to it.

The same is true of most water bottles employed in other countries. Water weights approximately seven pounds per gallon and as a consequence, the bottles can become very heavy if sized too large. Because of this weight factor, conventional plastic and glass water bottles are sized generally to hold five gallons or less of drinking water. Otherwise their weight would preclude the bottles from being easily moved and transported and would render them exceedingly hard to invert onto the stand or cooler.

Because of potential loss of business or liability for injury, great care is generally taken by the drink and water suppliers to make sure that the drink inside the vessel, such as water in the water bottles, is clean and potable. In most cases, water suppliers advertise a taste improvement of their bottled drink or health benefit of their water over local tap water. Consequently, water and drink bottlers go to great expense and trouble to make sure the water or drink inside the bottle is pure and potable. The same is true of drink suppliers such as cola manufacturers or vendors of drinking water in small to medium sized capped bottles.

To maintain the consumable liquid or water in the bottle in a pure germ or bacteria free state, once placed in the bottle, the cap is conventionally sealed over the aperture in the neck of the bottle which is air and liquid tight. This cap maintains a barrier between the drink or water inside the bottle and the germs, contaminants, and bacteria outside the bottle which the bottle certainly will encounter during shipping.

In addition to the aforementioned hazards from handlers of the container from manufacture to sale, other hazards can be caused by liquids which could melt or come in contact with the water in the bottle during shipment and particulate such as dirt and dust. Those too are precluded from contact with the consumable liquid or water inside the container by the sealed cap over the distal end of the neck of the bottle.

In the case of smaller bottles, storage usually consists of occupying a six-pak or single unit dispenser in the store until purchased and taken home. In the case of large five gallon water bottles, such bottles are stored on their side or with the neck upward and the flat portion of the bottle on the ground. During storage in this fashion, as noted, the cap sealed on the neck, maintains the liquid inside in a pure state free from particulate, liquids, germs, and bacteria and the like which may be found in the storage area outside the bottle.

In the case of large water bottles for dispensing from a cooler, as a consequence of the capped reservoir inside the bottle, the water in most bottles is in substantially the same state when the bottle is inverted onto a cooler or dispenser, as it was when it left the bottling plant.

Most people are familiar with the gurgling sound of a water bottle being inverted onto the dispenser. This sound occurs as the water bottle empties into the reservoir to a point until water, under the force of gravity, flows out of the water bottle into the reservoir of the cooler or dispenser until the pressure within the water bottle is reduced due to water evacuation from the bottle. Once pressure in the bottle is reduced to a degree sufficient to preclude further water outflow, the bottle ceases emptying.

This pressure in the bottle is maintained by the water level within the reservoir under the inverted bottle rising above the opening of the neck and prevents air inflow to the water bottle. The reservoir is in fluid communication with the spigot and as water is drawn from the spigot, the water level within the reservoir drops to a point just below the opening of the neck. Air then enters the water bottle and permits a quantity of water to flow out of the water bottle and into the reservoir feeding the spigot. As the water level in the reservoir rises above the opening of the neck, further air inflow is precluded and further water outflow from the water bottle stops. This process repeats until the bottle is empty.

However, as can be discerned from the forgoing description, the exterior surface of the bottle can be a haven for coatings and deposits of a plethora of pathogens, particulate, and liquids, which the bottle might encounter on the way to the user. In the United States, this might include the germs on the truck during transport, germs and bacteria and viruses on the hands of the water delivery person grabbing the bottle, or hazardous substances in the particulate or air surrounding the bottle during storage which settles as dust. It can also include cleaners and detergents which might coat the bottle. In third world countries, the bottle exterior might come in contact with much more exotic and toxic substances.

These germs, viruses, bacteria, chemical, and other potentially harmful substances, in the case of inverted water bottles, can easily contaminate the water in the reservoir since a portion of the aperture and surface of the bottle feeding the reservoir communicates with the exterior surface of the bottle surrounding the neck. A lot of splashing of water occurs when new bottles are turned over into the dispenser and can wash the contaminants into the reservoir. Even if splashing is minimized, the presence of germs and bacteria and viruses on the exterior of the bottle surrounding the neck are placed in direct proximity to the water stored in the reservoir.

In the case of smaller water and drink bottles, the risk is even more severe. Such bottles whether they house a cola, soft drink or water, all have exterior surfaces which come into direct contact with the mouth of the user.

There does as such, exist a major health risk to users of drinking bottles for both consumable liquids such as soft drinks as well as large five gallon style water bottles when inverted into the crock or reservoir portion of a cooler or dispenser. While the device herein is generally described in the most preferred mode for frequently ignored large cooler engaged water bottles, it is applicable to virtually any capped bottle storing a consumable liquid.

In the case of large cooler-engaged water bottles, germs, viruses, bacteria, particulate, and a host of other contaminants can potentially fall or make their way from the exterior surface of the bottle surrounding the neck, and into the reservoir below. Once in the reservoir, not only can they multiply, in the case of a cooler or dispenser used by an office or many people at a venue, these contaminants and pathogens have the potential to sicken a large number of people using the water dispenser.

Consequently, there exists an unmet need for a device which will sterilize or clean the area of a drinking vessel containing a consumable liquid of contaminants and pathogens which may gather thereon. Due to the sheer size of larger water bottles, the potential for contaminants is increased, especially on large cooler-engaged water bottles in the area surrounding the projecting neck and such a device should be available handily to clean that surface. Such a device should be available to users each and every time the cap is removed and/or a new bottle is inverted to fill the reservoir of a water dispenser. Such a device should be easily employed and available each and every time a new bottle is inverted without the chance for becoming lost in-between bottle replacements.

With respect to the above, before explaining at least one preferred embodiment of the invention in detail, it is to be understood that the invention is not limited in its application to the details of construction and to the arrangement of the components or steps set forth in the following description or illustrated in the drawings. Nor is it limited to the most preferred mode of the device described herein as adapted to clean large cooler-engaged water bottles. The various apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other easily deployed bottle exterior surface sterilizing and cleaning methods and systems adapted for use at the time of opening, for carrying out the several purposes of the present disclosed device. It is important, therefore, that the objects and claims be regarded as including such equivalent construction and methodology insofar as they do not depart from the spirit and scope of the present invention.

### SUMMARY OF THE INVENTION

The disclosed device provides great utility in solving the problems related to glass and plastic liquid containers and for large water bottles which are capped, transported, and stored, prior to being opened and inverted to an engagement with a water cooler or dispenser. In the particularly preferred mode of the device herein, its unique employment, in combination with the water bottle cap of large cooler-engaged water bottles, insures that the user has the ability to clean the area of the exterior of the bottle surrounding the neck each and every time a new bottle is engaged to the supporting water dispenser. Of course it can be adapted to engagement to smaller plastic and glass bottles housing consumable liquids such as designer water, or soft and juice drinks also.

The device features a disinfectant and/or cleaning solution such as alcohol, which is held by a cloth or paper media component which is sealed inside of a sealed cavity of a container. The cleaning media container or package can be metallic, coated paper, laminated paper, or can be a polymer or other material conventionally employed to form a sealed cavity around the cleaning wipes and maintain the wipe or swab in a moist and ready-to-use state while they are stored inside the package.

The package containing the wipe in a simple version of the device herein, might simply be glued or otherwise adhered to the exterior surface of the cap which is engaged to the bottle. In the case of the particularly preferred mode of the device used with large water bottles, this will allow for a means to clean each bottle to be available to the user immediately upon the task of inverting it onto the cooler so the surface surrounding the neck may be sanitized and cleaned without having to search for a cleaning component and cleaner to do so thereby encouraging use. The package containing the wipe in this mode would need to be sturdy and resist abrasion that could puncture the internal cavity. In the most preferred mode ensuring easy distribution and availability, it would also require a means of attachment to the bottle cap that will resist dislodgement during the highly abrasive and bumping the cap endures during transport of the bottle from the factory.

In a particularly preferred mode of the device herein which solves this detachment problem during transport, the cap would be included with a cavity in a combination with the package containing the swab or disinfectant media which would be housed inside the cavity in the cap. The cap would have the cavity within and easily be user-accessible, from the exposed end of the cap, which would thereby house and shield the package holding the moist swab disinfectant during transport of the bottle.

This cavity may be one that employs a removable sidewall which is disengageable from the cap itself to access the packaged swab. Or the cap may have a slot or aperture in a sidewall allowing insertion of a packaged swab into the cavity and removal through the slot for use. In a particularly preferred mode of the device, which is easily employable with any cap currently used for such a purpose, a small cavity or extra portion containing the cavity is included in the cap adjacent to the end surface of the cap covering the bottle aperture. The addition provides access to the cavity housing, the device herein, through removal of a wall, or reaching through an aperture with the fingers to pull the packaged swab therefrom.

Adding a wall surface that includes the storage cavity is also the easiest mode of the device that may be integrated into bottling lines without disrupting the conventional bottling and capping process. This is important to bottlers who may have millions invested in equipment that would not want to change the line at great expense.

With a small slit installed through the sidewall forming and covering such a cavity, the caps may be molded in the same fashion as is done with current cap manufacturing and the desired disinfectant and/or cleaner package, deposited through the slot into the cavity after manufacturing. This would allow different bottlers to insert their own customized packaged swab having indica on the exterior for advertising and instructions for use.

The formed sidewall forming and covering the cavity on the cap may be removable for access using a tab and slitting the sidewall to allow it to be torn if full access is desirable. The swab inside its package might also be placed inside a sealed cavity during molding of the cap using dies adapted to the purpose. Or the sidewall forming the cavity might be adhered to the existing exterior surface of the cap, such as would be the case with metal caps or twist off style metal or plastic caps.

Of course, other means to house or engage the packaged swab will occur to those skilled in the art upon reading this application. The overriding factor being to place an accessible sealed disinfectant and/or cleaning swab sealed in a package to each bottle and any means to form a cavity or recess that will provide adequate adhesion of the package and protection during transport as would occur to those skilled in the art is anticipated.

It is thus an object of this invention to provide a packaged media, infused with disinfectant or cleaning solution, and a means to engage such, to or within the cap on a drink container.

It is another object of the invention to provide a device for disinfecting and/or cleaning the area of an invertible water bottle surrounding the neck, prior to engagement to a water dispenser.

An additional object of this invention is to provide such a device which is made immediately available to users for each and every water bottle mounting by engaging it within or upon the cap which must be removed in the process, thereby encouraging use.

It is yet another object of this invention, to provide a disinfectant component and a cavity to house that component during shipment of the container by engagement of an additional sidewall to existing caps of drinking containers.

These together with other objects and advantages which will become subsequently apparent reside in the details of the construction and method as more fully hereinafter described and claimed, reference being had to the accompanying drawings forming a part thereof, wherein like numerals refer to like parts throughout.

### BRIEF DESCRIPTION OF DRAWINGS

FIG. 1 depicts the device showing the packaged swab adapted for engagement in a recess formed in the cap or sealed in a cavity formed by the recess and engageable sidewall.

FIG. 2 is a sectional view of another mode of the device wherein a cavity is formed on the exterior surface of the cap and has a pull tab to allow easy opening.

FIG. 3 depicts the device in a mode wherein an enclosure adapted for engagement to the top surface of a bottle cap is employed for bottles such as those having a screw-on or compression fit cap such as on smaller drink or water containers, conventionally used for sodas, soft drinks and juice.

### DETAILED DESCRIPTION OF THE PREFERRED EMBODIMENT

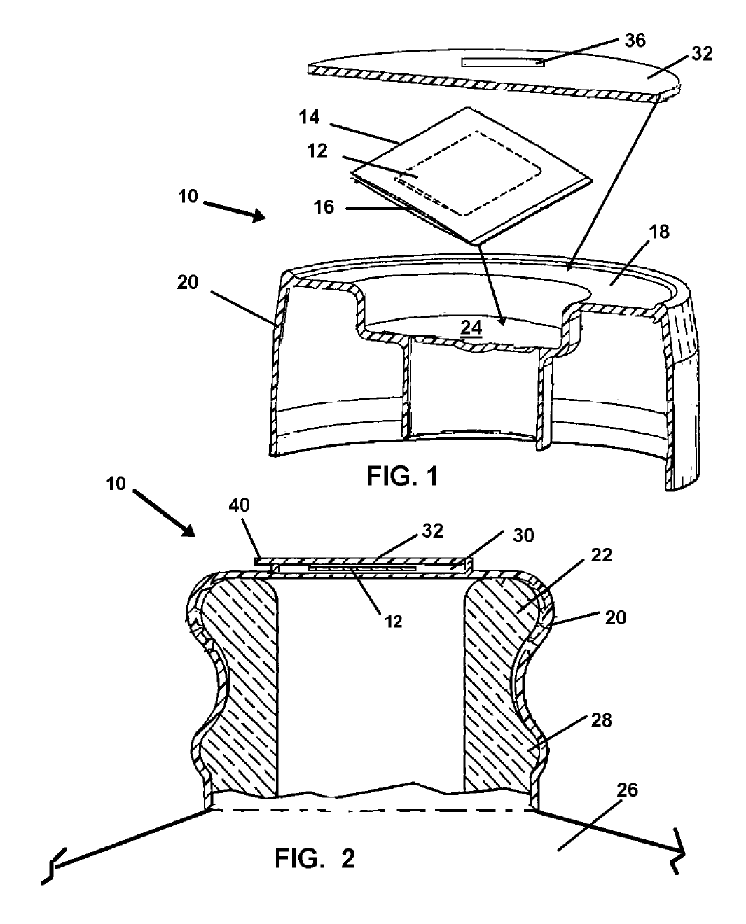

The device 10 herein is described and disclosed in FIGS. 1-3 wherein similar parts are identified by like reference numerals which may be found in one or more of the drawings.

As shown in FIG. 1, and employed in all modes of the device 10, there is a disinfectant and/or cleaning solution such as alcohol, which is held in a swab 12 which may be sealed inside of a sealed swab container 14. The swab container 14 should be fluid-impervious such as metallic material, coated paper, laminated paper, or can be a polymer such as polyethylene or other material conventionally employed to form a sealed cavity 16 around the cleaning swabs 12 and maintain the swab 12 in a moist and ready-to-use state. Alternatively, the swab 12 may be sealed within a cavity 30 formed in the cap 20 or as an attachable container which functions as the swab container 14 and is engageable to the exterior of the cap 20 thereby alleviating the need for the paper or fluid impervious swab container 14.

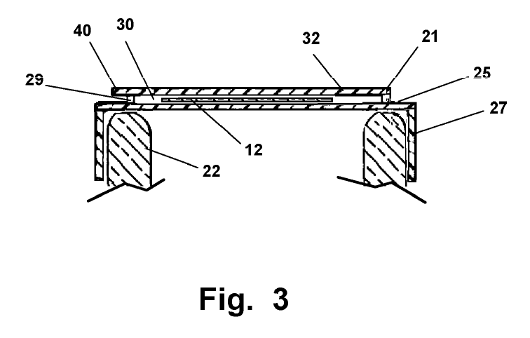

The container 14, operatively housing the swab 12, in a simple version of the device 10, may simply be glued or otherwise adhered to the exterior surface 18 of the cap 20 which is engaged to the bottle 22 as shown in FIG. 2, or combined with an engageable housing 21 adapted for attachment to the exterior surface 25 of a conventional cap 27 engaged on the neck 28 of a bottle either by compression as shown in FIG. 3, or by screwing the cap 27 thereon. However, adhering the container 14 to a simple flat surface leaves it exposed to possible harm during transport, and while less expensive to manufacture, this mode of the device 10 is less preferable.

In the preferred mode of the device 10, a cavity 30 is employed to provide means for protection of the container 14 during transport, yet still provide the swabs 12 within immediate proximity to the user at the time of opening of the water or other bottle 22. If employed in this especially preferred mode on or as part of the cap 20, such as on a large water bottle for inverted mounting on a water cooler, the cap 20 will preferably have the cavity 30 formed therein or on its exposed surface 18 to protect the container 14 from abrasion and possible puncture or dislodgement during transport and storage. Upon the need to invert the bottle 22 on the cooler or dispenser, the container 14 would be pulled from the cavity 30 in the cap 20 and torn or cut open to allow removal of the swab 12 to clean the bottle in skirt 26 area of the bottle surrounding the neck 28.

In this preferred mode of the device 10, the user always will have a swab 12 immediately available during uncapping of the bottle 22 and thereby be provided with a means to urge use of the device 10 to clean the bottle 22 surfaces before use. Human nature being what it is, absent the proximate locating of the device 10 and swab 12 in the immediate vicinity of the cap 20 during an opening of a bottle 22, users would probably not be as vigilant in cleaning of the bottle 22 since it would take time or effort to go find a cleaning swab 12.

In a particularly preferred mode of the device 10 herein which offers additional protection to the swab 12 and container 14 during the rough transport afforded water bottles 22 on trucks and the like, the cap 20 may have a sealed cavity 30 which would provide the protective storage with a removable cover portion or sidewall 32 which would shield the container 14 and swab 12 in the cavity 30 during transport. The swab-protecting container 14 with swab 12 sealed therein, would itself be sealed in the cavity 30 for transport during manufacturing of the cap 20, thereby protecting it from harm. Since the cap 20 would be manufactured with the swab 12 contained therein, cap manufacturers supplying bottlers will be able to provide the bottler with caps 22 which may immediately be employed in existing manufacturing processes.

Alternatively, the sidewall 32, as shown in FIG. 1, may be formed with a slot 36 or other aperture therein and thereby allowing a means to insert a packaged swab 12 in the already formed cavity 30. If the slot 36 is large enough, the swab 12 may be removed through it for use. If not, the sidewall 32 would be rendered removable from the cap 20 allowing access to the cavity 30. This can be done by perforation or rendering the sidewall 32 frangible from the cap 20 itself. In another mode of the device 10 as in FIG. 3, the cavity 30 might be formed separately from the cap 20, and with the swab 12 engaged therein, joined to the cap 20 in a second step. If the cavity 30 is formed separate, it would employ adhesive or other means to adhere it to the cap 20.

Employing the slot 36 in a sidewall covering such a cavity 30, will allow cap manufacturers to supply bottlers with caps in a conventional fashion. The slot 36 or aperture will also allow different bottlers to insert their own customized packaged swab 12 having indica on the exterior for advertising, and instructions for use, thus allowing one cap manufacturer to continue providing a plurality of bottlers. The formed sidewall 36 covering the cavity 30 on the cap 20 may be rendered easily removed using a tab 40 and rendering the surface surrounding the sidewall 32 slotted or otherwise easily frangible to allow it to be torn away.

Employing the device 10 herein with the sealed swab 12 engaged to, or housed in a cavity 30 in or engaged to the cap 20, provides means to clean and/or sterilize the water bottle 22 on the neck and surround areas which may communicate with the reservoirs of water coolers in a fashion rendering a new clean swab 12 available each time a bottle 22 is uncapped, thereby encouraging use. Employed on a smaller drinking bottle for water or soft drinks, the swab 12 may be used to clean the bottle surface and neck to protect the user. Since a swab 12 is provided with each bottle 22 it will encourage use by users who might not make the effort, were they to have to find a swab 12 elsewhere.

Another preferred mode of the device 10 in FIG. 3 depicts a mode wherein a housing 21 having a cavity 30 formed therein, is adapted for engagement to the top surface 25 of a bottle cap 27 of the twist off or compression engagement variety. As in the mode of the device 10 where the cavity 30 is formed in the cap 20 itself, engaging the housing 21 with a cavity, 30 therein provides a protective storage enclosure for the container 14 and swab 12 therein.

In this mode, the housing 21 may simply provide a cavity 30 or may also provide the protective sidewall 32 with or without the slot 36. A bottom surface 29 of the housing 21 would adhere to the top surface 25 of the cap 27. Of course the mode of the device 10 of FIG. 3, could also be adapted for use with a large water bottle style cap noted above wherein the housing 21 would engage to the water bottle cap 20 and provide the cavity 30 with or without the sidewall 32 depending on the amount of protection to the container 14 is desired.

While all of the fundamental characteristics and features of the cap housed cleaning and sterilizing device and method for a water bottle have been disclosed and described, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A cleaning apparatus for a container holding consumable liquids comprising:
a cleaning pad having a cleaning solution absorbed therein, said cleaning pad sealed in a cavity within a pad container; and
said pad container in an engagement with a cap, said cap being removably engageable to seal an opening of a liquid container holding a consumable liquid, whereby said cleaning pad is held in said cavity immediately adjacent to said opening of said liquid container, and available in a position for use in a cleaning of said liquid container by a user.

2. The device of claim 1 additionally comprising:
said pad container is a said cavity formed integral to said cap; and
means to access said pad within said pad container.

3. The device of claim 1 additionally comprising:
said pad container is a sealed cover having said cavity therein;
said sealed cover openable through a tearing thereof to reveal said pad within said cavity; and
means of engagement of said sealed cover to said cap.

4. The device of claim 1 additionally comprising:
said pad container is a sealed cover having said cavity therein;
said engagement with said cap is a placement of said sealed cover within a substantially enclosed space formed integral to said cap; and
means to access said sealed cover within said enclosed space.

5. The device of claim 4 additionally comprising:
said means to access said sealed cover is an aperture formed in a sidewall of said cap, said sidewall forming a portion of a wall surface defining said enclosed space, said aperture communicating between said enclosed space and an area exterior to said cap.

6. The device of claim 4 wherein said means to access said enclosed space is an a sidewall, said sidewall forming a portion of a wall surface defining said enclosed space;
means for removable engagement of said sidewall to said cap, whereby a removal of said sidewall affords access to said pad container.

7. The device of claim 6 wherein said means for removable engagement of said sidewall to said cap is a perforation of said sidewall allowing for removal through a tearing of said sidewall from said cap.

8. The device of claim 2 wherein said means to access said pad in said container is an a sidewall, said sidewall forming a portion of a wall surface defining said cavity;
means for removable engagement of said sidewall to said cap, whereby a removal of said sidewall affords access to said cavity serving as said pad container.

9. The device of claim 8 wherein said means for removable engagement of said sidewall to said cap is a perforation of said sidewall allowing for removal through a tearing of said sidewall from said cap.

10. A method of cleaning a container holding consumable liquids before use by a user, said container having a cap, and having a cleaning pad with a cleaning solution absorbed therein, said cleaning pad housed in a cavity formed integral to said cap and accessible through a sidewall, comprising the steps of:
removing said sidewall to provide access to said cleaning pad;
removing said cap from said cleaning container; and
employing said cleaning pad to clean said container.

11. The method of claim 10 additionally comprising the additional steps of:
removing said cleaning pad from a container positioned inside said cavity in said cap after having removed said sidewall.
